(19) United States
(12) Patent Application Publication
(10) Pub. No.: US 2014/0295120 A1
(43) Pub. Date: Oct. 2, 2014

(54) LABEL MOUNT, LABEL WITH MOUNT, AND PRODUCTION METHOD THEREOF

(71) Applicants: Casio Computer Co., Ltd., Tokyo (JP); Casio Electronics Manufacturing Co., Ltd., Iruma-shi (JP)

(72) Inventor: Tomohumi SANO, Iruma-shi (JP)

(73) Assignees: Casio Computer Co., Ltd., Tokyo (JP); Casio Electronics Manufacturing Co., Ltd., Iruma-shi (JP)

(21) Appl. No.: 14/221,761

(22) Filed: Mar. 21, 2014

(30) Foreign Application Priority Data
Mar. 29, 2013 (JP) 2013-074047

(51) Int. Cl. G09F 3/10

(52) U.S. Cl. CPC G09F 3/10
USPC 428/40.2; 156/241

(57) ABSTRACT

A label mount of the present invention is characterized by containing: a release sheet 21; an adhesive layer 22 provided on a surface of the release sheet; and a coat layer 12 provided on the adhesive layer, containing a resin, and particles being harder as compared with the resin.

### CROSS-REFERENCE TO RELATED APPLICATION

This application is based upon and claims the benefit of priority of Japanese Patent Applications No. 2013-074047 filed on Mar. 29, 2013, the entire disclosure of which is incorporated herein by reference in its entirety.

### BACKGROUND OF THE INVENTION

1. Field of the Invention

The present invention relates to, for example, a label mount, a label with mount and an adhesive label, and a production method thereof.

2. Description of the Prior Art

A label with mount has been produced by the following method in general. Firstly, a label paper in which an adhesive layer is provided on one surface, and the adhesive layer is covered with a release paper, is prepared. Next, a picture pattern is printed on the label paper, and then the printed label paper is cut to an arbitrary shape.

A label with mount can be produced even by another method. For example, in Japanese Patent Application Laid-Open (JP-A) No. 2007-283745, a method and an apparatus in which firstly, a release paper, on one surface of which an adhesive layer is provided is prepared; next, a pattern composed of toner is provided on the adhesive layer using an electrophotography method; and then by adding heat and pressure to the resultant, a film in which this pattern can be handled by itself is formed, have been proposed. Further, for example, in JP-A No. 2010-184470, a method in which an ultraviolet curable resin is used as a binder resin of toner, and to the pattern, irradiation with ultraviolet rays is performed at the same time of the addition of heat and pressure, has been proposed. According to these methods, a label can be formed in an arbitrary shape on demand without using a blade.

In a method of using these electrophotography methods, when a label with mount is produced, it is required to prepare a release paper to which an adhesive has been applied. A release paper to which an adhesive has been applied may, for example, interfere with the transport and the like in a printer when the adhesive is in a state of being exposed on the surface, and thus is inconvenient to be handled. Therefore, it is easy to use in practical when the surface of the adhesive is coated with a layer having a lower viscosity. Thus, for example, as in JP-A No. 2007-283745, it has been investigated to use a label mount in which the adhesive layer is covered with a coat layer composed of a thermoplastic resin.

However, in the case where a coat layer composed of only a thermoplastic resin is provided, the followability of the adhesive layer becomes deteriorated when the adhesive label is peeled from the release paper. For example, in an adhesive layer, not only the portion that is positioned directly below the label but also the portion that is positioned below the vicinity of the label may be peeled together with the coat layer from the release paper.

### SUMMARY OF THE INVENTION

The present invention has been made in view of the circumstances described above, and an object of the present invention is to provide a label mount provided with a coat layer that is easily cut off following the shape of the label, and a label with mount.

In order to solve the problems described above and to achieve the object, each of a label mount, a label with mount, and a production method thereof of the present invention is configured in the following.

A label mount of the present invention including: a release sheet; an adhesive layer provided on a surface of the release sheet; and a coat layer provided on the adhesive layer, containing a resin, and particles being harder as compared with the resin; in which an average particle diameter of the particles is 0.3 μm or more.

Further, a method for producing a label mount of the present invention including the steps of: forming a coat layer releasably supported by a surface of a first release sheet by applying a dispersion containing a resin, and particles being harder as compared with the resin, onto the surface of the first release sheet; pressurizing by bonding the first release sheet, and a second release sheet, on a surface of the second release sheet an adhesive layer being releasably supported, so that the coat layer and the adhesive layer are interposed between the first release sheet and the second release sheet; and then releasing the first release sheet from the coat layer.

Furthermore, a label with mount of the present invention including: a label mount containing a release sheet, an adhesive layer provided on a surface of the release sheet, and a coat layer provided on the adhesive layer and containing a resin, and particles being harder as compared with the resin; and a label composed of toner, and partially coating the coat layer; in which an average particle diameter of the particles is 0.3 μm or more.

### BRIEF DESCRIPTION OF THE DRAWINGS

FIG. 1 is a sectional view schematically showing a label mount according to one embodiment of the present invention;

FIG. 2 is a sectional view schematically showing the step of forming a coat layer in the production of the label mount shown in FIG. 1;

FIG. 3 is a sectional view schematically showing the step of forming an adhesive layer in the production of the label mount shown in FIG. 1;

FIG. 4 is a sectional view schematically showing the step of bonding in the production of the label mount shown in FIG. 1;

FIG. 5 is a sectional view schematically showing an example of a label with mount that is produced by using the label mount shown in FIG. 1; and

FIG. 6 is a sectional view schematically showing an example of an adhesive label that is produced by using the label mount shown in FIG. 1.

### DESCRIPTION OF THE PREFERRED EMBODIMENTS

Hereinafter, the embodiment of the present invention will be described with reference to the drawings. In addition, the components exhibiting the same or similar functions will be denoted by the same reference numerals throughout the drawings, and overlapping description is omitted.

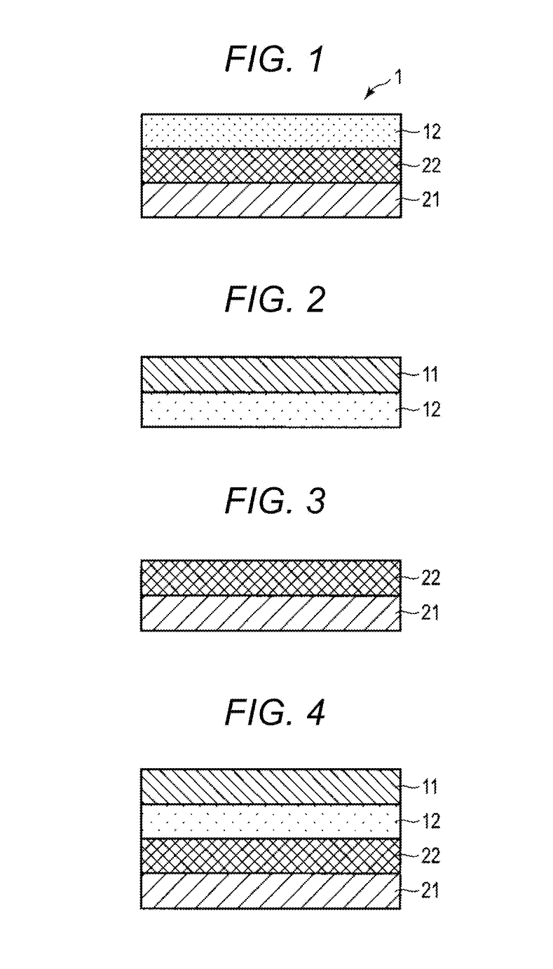

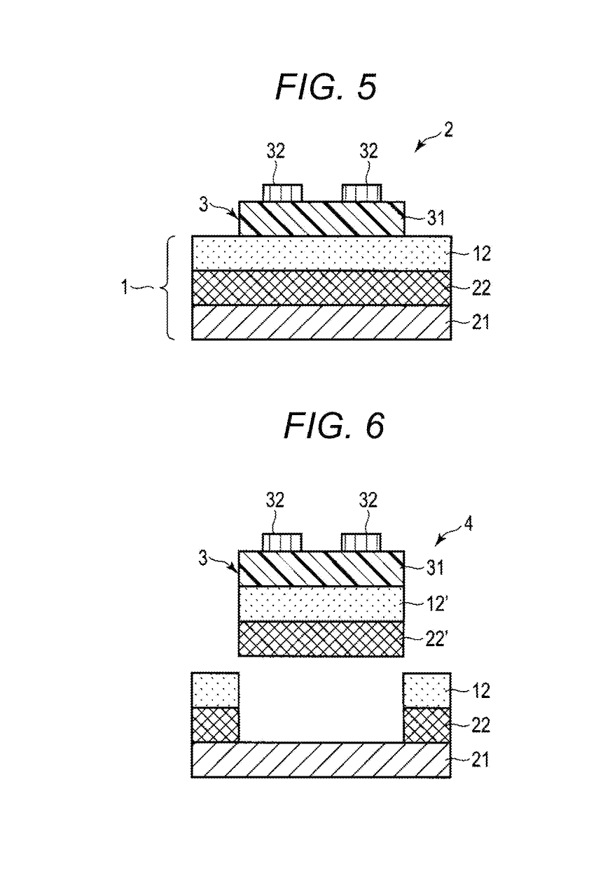

FIG. 1 is a sectional view schematically showing a label mount according to one embodiment of the present invention. FIG. 5 is a sectional view schematically showing an example of a label with mount that is produced by using the label mount shown in FIG. 1. FIG. 6 is a sectional view schematically showing an example of an adhesive label that is produced by using the label mount shown in FIG. 1.

The label mount 1 shown in FIG. 1 contains a release sheet 21, an adhesive layer 22, and a coat layer 12. The release sheet 21 releasably supports the adhesive layer. Typically, the coat layer 12 is provided so as to cover the entire surface or almost the entire surface of the adhesive layer 22.

The label with mount 2 shown in FIG. 5 contains a label mount 1, and a label 3 provided on the coat layer 12. The adhesive label 4 shown in FIG. 6 is an adhesive label that is obtained by peeling the label 3 from the release sheet 21 together with the portion 12′ of the coat layer 12, which is positioned below the label 3, and the portion 22′ of the adhesive layer 22, which is positioned below the label 3, in the label with mount 2 shown in FIG. 5.

The adhesive layer 22 is a layer composed of an adhesive that is generally used, such as an acrylic adhesive, and a rubber adhesive. The parameter of adhesive layer 22 such as adhesion, and tack, can be appropriately changed in accordance with the application of the label 3.

The coat layer 12 contains a resin, and particles that are harder as compared with the resin. By covering the adhesive layer 22, the coat layer 12 makes the handling of the label mount 1 easier. Further, typically, the refractive index of the resin is different from that of the particles, therefore, the coat layer 12 is light scattering. When the light scattering is sufficiently strong, the coat layer 12 appears white. White image displayed by such a coat layer 12 can be used as the background of the image displayed by the label 3.

The resin contained in a coat layer 12 serves to smooth the surface of the coat layer 12 in addition to supporting the particles. The resin typically does not have adhesiveness. As the resin of the coat layer 12, for example, polyester, polystyrene, an acrylic resin, a nylon resin, polyimide, a urea resin, an epoxy resin, a melamine resin, polyethylene, polypropylene, a cyclic olefin resin, an ionomer resin, polyvinyl acetate, polyvinyl alcohol, polyvinyl chloride, polyvinylidene chloride, polycarbonate, polyacrylonitrile, and a copolymer thereof can be used.

The particles contained in a coat layer 12 serve to easily cut the coat layer 12. As the particles, typically, inorganic particles are used. For example, inorganic particles composed of an inorganic substance such as silica, calcium carbonate, talc, sillitin, aluminum hydroxide, aluminum oxide, kaolin, calcined kaolin, zinc sulfate, zinc oxide, barium sulfate, titanium oxide, and zirconium oxide can be used.

In addition, resin particles composed of an acrylic resin, a styrene resin, a fluorine-based resin, polyethylene, polypropylene, polyester, an epoxy resin, a melamine resin, a copolymer thereof, and the like can be used. However, in this case, it is required to select a resin and/or solvent in which resin particles are not dissolved into a solvent during the formation of a coat layer 12. The particles may be used only one kind selected from the inorganic particles and resin particles, or may be used in combination of two or more kinds.

The shape of particle is different depending on the material. Further, the shape of particle may affect the followability of a coat layer 12 to a label 3, and the smoothness of surface of a coat layer 12. For example, when talc is used as the particles, talc is in a plate shape, therefore, in a coat layer 12, each flat part of talc particles is oriented substantially parallel to the coated surface. As a result, a coat layer 12 having a favorable appearance, the surface of which is smoother, can be obtained. Further, by the mixture of two or more kinds of particles, the followability of a coat layer 12 to a label 3 can be controlled, and a coat layer 12, the surface of which has an intended smoothness, can be obtained.

The particle size is typically 0.3 μm or more, and preferably 1.0 μm or more. When the particles having a particle diameter smaller than the above are used, the strength of coat layer 12 becomes excessively strong, that is, a coat layer 12 becomes excessively hard, and thus the followability of a coat layer 12 to a label 3 may become insufficient. Incidentally, in the Examples described later, the following results are obtained. When the particle diameter is 0.3 μm and 0.5 μm, the followability is favorable, and when the particle diameter is in the range of 1.0 μm to 11 μm, the followability is extremely favorable. Further, the particle size indicates volume average particle diameter (D50), and this measurement method will be described later.

The mass of the particles contained in a coat layer 12 is, for example, 1 to 20 times, and preferably 2 to 10 times that of the resin contained in a coat layer 12. In the case where the particles are excessively few, when a label 3 is peeled from the release sheet 21 in a label with mount 2, the resin is extended, as a result, not only the portion of the coat layer 12, which is positioned directly below the label 3 but also the portion that is positioned below the vicinity of the label 3 may be peeled from the release sheet 21. In the case where the particles are excessively many, the physical strength of the label becomes deteriorated.

The thickness of the coat layer 12 is preferably 20 μm or less. When the thickness is excessively thick, at least a part of the portion of the coat layer 12, which is positioned directly below the label 3, may be peeled from the label 3 without sufficiently following to the label 3.

A label 3 is composed of toner. A label 3 is provided on a coat layer 12 by using an electrophotography method. A label 3 partially coats the coat layer 12.

The label 3 contains a label base material 31, and a printed layer 32 provided on the label base material 31. Each of the label base material 31 and the printed layer 32 is composed of toner. Each of the label base material 31 and the printed layer 32 is formed by using an electrophotography method.

The toner used for the formation of a label base material 31 is obtained by the mixture of a binder resin, a charge control agent, typically a releasing agent, and the like, and by the melt-kneading and pulverization of the resultant mixture.

As the binder resin, a thermoplastic resin that is generally used for a film is used. For example, a polybutylene succinate-based resin, a polyethylene-based resin, a polypropylene-based resin, a crystalline polyester resin, polyester, polystyrene, an acrylic resin, a nylon resin, polyimide, a urea resin, an epoxy resin, a melamine resin, polyethylene, polypropylene, a cyclic olefin resin, an ionomer resin, polyvinyl acetate, polyvinyl alcohol, polyvinyl chloride, polyvinylidene chloride, polycarbonate, polyacrylonitrile, and a copolymer thereof can be used. These resins may be used alone, or may be used in combination of two s.

A charge control agent is added to adjust the charge amount and charging speed of toner. As the charge control agent, any charge control agent that is generally used for electrophotographic toner can be used.

A releasing agent is added to prevent the offset phenomenon in which part of toner is divided and adheres to the heated surface, when the toner developed by contact heat fixing such as heat roller fixing is fixed to a release sheet. As the releasing agent, any releasing agent that is generally used for electrophotographic toner can be used. If it is not required to impart a releasing effect, the releasing agent may not be added.

The toner used for the formation of a printed layer 32, for example, is an ordinary toner that is used for the printing onto paper, and the like. In the formation of a printed layer 32, a mixture that is obtained by the addition of a coloring agent to the toner described in the section of label base material 31 may be used.

When the surface of the side of printed layer 32 of label 3 is used as the display surface, the label base material 31 may have light permeability, or may have light shieldability. When the surface of the opposite side of printed layer 32 of label 3 is used as the display surface, the label base material 31, the coat layer 12, and the adhesive layer 22 are required to have light permeability.

The printed layer 32 may be interposed between the label base material 31 and the coat layer 12. When such a structure is employed, and the surface of the side of printed layer 32 of label 3 is used as the display surface, the coat layer 12, and the adhesive layer 22 are required to have light permeability. Further, when such a structure is employed, and the surface of the opposite side of printed layer 32 of label 3 is used as the display surface, the label base material 31 is required to have light permeability.

Next, a production method of each of the above-described label mount 1 and the label with mount 2 will be described.

FIGS. 2 to 4 are sectional views showing the production steps of the label mount shown in FIG. 1.

Firstly, a resin is dissolved in a solvent, and a resin solution is prepared. Next, into the resin solution, for example, inorganic particles are added in a mass 7 times that of the resin, and the resultant mixture is subjected to ultrasonic dispersion. The dispersion is applied on a first release sheet 11, and the resultant is dried, and thus as shown in FIG. 2, the first release sheet 11 supporting a coat layer 12 is formed. Further, separately, as shown in FIG. 3, a second release sheet releasably supporting an adhesive layer 22 is prepared.

Subsequently, the first release sheet 11, on one surface of which a coat layer 12 is formed, and the second release sheet 21, on one surface of which an adhesive layer 22 is formed, are bonded and pressurized so that the coat layer 12 and the adhesive layer 22 are interposed between the first release sheet and the second release sheet.

Further, the first release sheet 11 is peeled from the coat layer 12, and thus a label mount 1 shown in FIG. 1 is obtained.

After that, the label base material 31 and printed layer 32 that have been formed by using an electrophotography method are transferred onto the coat layer 12 sequentially or at the same time, and thus a label with mount 2 shown in FIG. 5 is obtained.

In this method, a coat layer 12 is not formed onto the adhesive layer 22, but is formed onto the first release sheet 11. Therefore, if the surface of the first release sheet is sufficiently smooth, the surface of the coat layer 12 is also smooth. Such a coat layer 12 is advantageous in order to display an image to the label 3 in high quality. Further, when the surface of the first release sheet 11 has a rugged structure, the surface of the coat layer 12 also has a rugged structure. Such a coat layer 12 can achieve high adhesion between the label 3 and the coat layer 12.

### EXAMPLES

Hereinafter, Examples according to the present invention will be specifically described.

At the beginning, a method for measuring the physical properties that will be described later is shown below.

For the measurement of particle size of the particle of coat layer, “LA-920” manufactured by HORIBA, Ltd. was used. Herein, a small amount of sample was placed in a beaker together with purified water and a surfactant, the resultant mixture was dispersed by an ultrasonic washing machine to make a dispersion, and the dispersion was used for the measurement. The measurement was performed with an aperture of 100 μm and the counting of 50,000, and thus the volume average particle diameter (D50) was obtained.

The measurement of toner particle diameter was performed in the same manner as in the measurement of the particle diameter of the particles of coat layer except that as an apparatus, “FPIA-2100” manufactured by Sysmex Corporation was used.

In the measurement of the softening point, “CFT-500D” manufactured by Shimadzu Corporation was used, the sample was 1 g, the rising temperature was 6° C./min, the load was 20 kg, a nozzle having a diameter of 1 mm and a length of 1 mm was used, and thus the temperature at which half of the sample had flowed out with a ½ method was set to the softening point.

### <Preparation of Label Mount>

### Example 1

As a resin, polyester resin Ecoflex F-BX7011 (manufactured by BASF) was used to be dissolved into tetrahydrofuran (THF), thus a 10% solution was prepared. Into the resin solution, as particles, silica particles KE-P30 (manufactured by NIPPON SHOKUBAI CO., LTD.) were added in a mass 7 times that of the resin, and the resultant mixture was subjected to ultrasonic dispersion. This dispersion was applied by a coater to form a thin layer onto the first release sheet made of PET and the thin layer was dried, thus the first release sheet supporting a coat layer having a thickness of 7 μm was formed.

Subsequently, the first release sheet, on one surface of which a coat layer had been formed, and the second release sheet made of PET, on one surface of which an adhesive layer had been formed by the application of acrylic adhesive, are bonded and pressurized so that the coat layer and the adhesive layer could be interposed between the first release sheet and the second release sheet.

Further, the first release sheet was released from the coat layer, and thus a label mount was formed.

### Example 2

A label mount was formed in the same manner as in Example 1 except that as the particles, silica particles KE-P50 (manufactured by NIPPON SHOKUBAI CO., LTD.) were used. Further, the thickness of the coat layer was 8 μm.

### Example 3

A label mount was formed in the same manner as in Example 1 except that as the particles, silica particles KE-P100 (manufactured by NIPPON SHOKUBAI CO., LTD.) were used. Further, the thickness of the coat layer was 10 μm.

### Example 4

A label mount was formed in the same manner as in Example 1 except that as the particles, silica particles KE-P150 (manufactured by NIPPON SHOKUBAI CO., LTD.) were used. Further, the thickness of the coat layer was 10 μm.

### Example 5

A label mount was formed in the same manner as in Example 1 except that as the particles, talc particles SG-95 (manufactured by Nippon Talc Co., Ltd.) were used. Further, the thickness of the coat layer was 11 μm.

### Example 6

A label mount was formed in the same manner as in Example 1 except that as the particles, talc particles P-2 (manufactured by Nippon Talc Co., Ltd.) were used. Further, the thickness of the coat layer was 13 μm.

### Example 7

A label mount was formed in the same manner as in Example 1 except that as the particles, sillitin particles Sillikolloid P87 (manufactured by Hoffmann Mineral) were used. Further, the thickness of the coat layer was 12 μm.

### Example 8

A label mount was formed in the same manner as in Example 1 except that as the particles, calcium carbonate particles μ-Powder 3N (manufactured by SHIRAISHI CALCIUM KAISHA, LTD.) were used. Further, the thickness of the coat layer was 10 μm.

### Comparative Example 1

A label mount was formed in the same manner as in Example 1 except that as the particles, silica particles KE-P10 (manufactured by NIPPON SHOKUBAI CO., LTD.) were used.

### Comparative Example 2

A label mount was formed in the same manner as in Example 1 except that particles were not used.

In order to evaluate these label mounts, a label with mount was produced as described below.

### <Production of Toner>

Firstly, polybutylene succinic acid to be used as a binder resin of toner was synthesized. Specifically, 0.4 parts by mass of malic acid and 1 part by mass of germanium dioxide were dissolved into 100 parts by mass of 88% aqueous lactic acid solution, 5.4 parts by mass of the resultant mixture was added into 100 parts by mass of succinic acid and 89 parts by mass of 1,4-butanediol. The inside of the reaction system was set to a nitrogen atmosphere, then the resultant mixture was reacted at 220° C. for one hour, and subsequently the pressure of the inside was reduced to 70 Pa over 1.5 hours while the temperature was raised up to 230° C. After that, the reaction was further performed for 2 hours, the polymerization was allowed to proceed, and thus polybutylene succinic acid was obtained.

96.5 parts by mass of this polybutylene succinic acid, 1 part by mass of LR-147 (manufactured by Japan Carlit Co., Ltd.) that is a charge control agent, and 2.5 parts by mass of Carnauba Wax (manufactured by S. Kato & Co.) that is a releasing agent were mixed, and kneaded by a twin-screw extruder kneading machine. The kneaded material was pulverized under liquid nitrogen by using Linrex Mill manufactured by Hosokawa Micron, and thus powders having a D50 (volume) of 37 μm were obtained.

100 parts by mass of the obtained powders, 0.2 part by mass of the hydrophobized silica particles RY200 (manufactured by Nippon Aerosil Co., Ltd.), and 0.7 part by mass of the also hydrophobized silica particles NY50 (manufactured by Nippon Aerosil Co., Ltd.) were stirred by using a Henschel mixer, and thus toner having a D50 (volume) of 37 μm and a softening point of 125° C. was obtained.

<Production of Label with Mount>

By using each label mount that had been prepared in each of Examples 1 to 8 and Comparative Example 1 to 2, and the toner described above, a label with mount was produced as the following. That is, by using an electrophotography method, toner as a label base material was developed onto a label mount of A4 size, the resultant was passed through a heat roll of 180° C. to fix the toner, and thus a label with mount was obtained. Subsequently, on a label base material, by using a N5300 printer manufactured by CASIO COMPUTER CO., LTD., an image as a printed layer was developed and fixed.

As to each label with mount thus produced, when the adhesive label was peeled from the release sheet, it was evaluated whether or not the label with mount could be peeled following the shape of the label, based on the following criteria.

◯: Could be peeled off following the label shape.

Δ: Could be peeled off roughly following the label shape.

×: Could not be peeled off following the label shape, and had a practical problem.

These results are summarized in Table 1.

TABLE 1

| | | Particle size | Coat layer | |
|---|---|---|---|---|
| | | (D50 | thickness | Followability |
| | Particles | volume μm) | (μm) | to label |
| Example 1 | Silica | 0.3 | 7 | Δ |
| Example 2 | Silica | 0.5 | 8 | Δ |
| Example 3 | Silica | 1 | 10 | ∘ |
| Example 4 | Silica | 1.5 | 10 | ∘ |
| Example 5 | Talc | 2.5 | 11 | ∘ |
| Example 6 | Talc | 11 | 13 | ∘ |
| Example 7 | Sillitin | 3.9 | 12 | ∘ |
| Example 8 | Calcium | 1.3 | 10 | ∘ |
| | carbonate | | | |
| Comparative | Silica | 0.1 | 7 | x |
| Example 1 | | | | |
| Comparative | None | — | — | x |
| Example 2 | | | | |

As shown in Table 1, all of the labels with mount according to Examples 1 to 8, in which as the particles, silica, talc, sillitin, or calcium carbonate had been used, showed a sufficient level of followability. In the label with mount according to Comparative Example 2, in which particles had not been used, sufficient followability could not been obtained. And also, in the label with mount according to Comparative Example 1, in which the average particle diameter of the particles is 0.1 μm, sufficient followability could not been obtained.

In addition, the coat layer of the label with mount according to Example 8, in which as the particles, calcium carbonate had been used, as compared with the coat layers of other Examples, had stronger light scattering, and more favorable followability to a label, and further is more practical because the calcium carbonate is relatively inexpensive.

Herein, as the particles, only the silica, talc, sillitin, or calcium carbonate had been used, however, in addition to these, the inorganic particles or resin particles described above can be used.

In addition, of course various modifications can be performed without departing from the scope of the present invention.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

1. A label mount, comprising:
a release sheet;
an adhesive layer provided on a surface of the release sheet; and
a coat layer provided on the adhesive layer, containing a resin, and particles being harder as compared with the resin;
wherein an average particle diameter of the particles is 0.3 μm or more.

2. The label mount according to claim 1,
wherein the particles are obtained by mixing inorganic particles or resin particles, or inorganic particles and resin particles.

3. The label mount according to claim 2,
wherein the particles are composed of one or more kinds of substances selected from the group consisting of silica, calcium carbonate, talc, sillitin, aluminum hydroxide, aluminum oxide, kaolin, calcined kaolin, zinc sulfate, zinc oxide, barium sulfate, titanium oxide and zirconium oxide, and an acrylic resin, a styrene resin, a fluorine-based resin, polyethylene, polypropylene, polyester, an epoxy resin, a melamine resin, and a copolymer thereof.

4. The label mount according to claim 3,
wherein the coat layer contains the particles in a mass 1 to 20 times that of the resin.

5. The label mount according to claim 1,
wherein the particles are composed of one or more kinds of substances selected from the group consisting of silica, calcium carbonate, talc, sillitin, aluminum hydroxide, aluminum oxide, kaolin, calcined kaolin, zinc sulfate, zinc oxide, barium sulfate, titanium oxide and zirconium oxide, and an acrylic resin, a styrene resin, a fluorine-based resin, polyethylene, polypropylene, polyester, an epoxy resin, a melamine resin, and a copolymer thereof.

6. The label mount according to claim 1,
wherein the coat layer contains the particles in a mass 1 to 20 times that of the resin.

7. A method for producing a label mount, comprising the steps of:
forming a coat layer releasably supported by a surface of a first release sheet by applying a dispersion containing a resin, and particles being harder as compared with the resin, onto the surface of the first release sheet;
pressurizing by bonding the first release sheet, and a second release sheet, on a surface of the second release sheet an adhesive layer being releasably supported, so that the coat layer and the adhesive layer are interposed between the first release sheet and the second release sheet; and then
releasing the first release sheet from the coat layer.

8. A label with mount, comprising:
a label mount containing a release sheet, an adhesive layer provided on a surface of the release sheet, and a coat layer provided on the adhesive layer and containing a resin, and particles being harder as compared with the resin; and
a label composed of toner, and partially coating the coat layer;
wherein an average particle diameter of the particles is 0.3 μm or more.

9. The label with mount according to claim 8,
wherein the particles are obtained by mixing inorganic particles or resin particles, or inorganic particles and resin particles.

10. The label with mount according to claim 9,
wherein the particles are composed of one or more kinds of substances selected from the group consisting of silica, calcium carbonate, talc, sillitin, aluminum hydroxide, aluminum oxide, kaolin, calcined kaolin, zinc sulfate, zinc oxide, barium sulfate, titanium oxide and zirconium oxide, and an acrylic resin, a styrene resin, a fluorine-based resin, polyethylene, polypropylene, polyester, an epoxy resin, a melamine resin, and a copolymer thereof.

11. The label with mount according to claim 10,
wherein the coat layer contains the particles in a mass 1 to 20 times that of the resin.

12. The label with mount according to claim 8,
wherein the particles are composed of one or more kinds of substances selected from the group consisting of silica, calcium carbonate, talc, sillitin, aluminum hydroxide, aluminum oxide, kaolin, calcined kaolin, zinc sulfate, zinc oxide, barium sulfate, titanium oxide and zirconium oxide, and an acrylic resin, a styrene resin, a fluorine-based resin, polyethylene, polypropylene, polyester, an epoxy resin, a melamine resin, and a copolymer thereof.

13. The label with mount according to claim 8,
wherein the coat layer contains the particles in a mass 1 to 20 times that of the resin.
